(19) United States
(12) Patent Application Publication
(10) Pub. No.: US 2011/0118880 A1
(43) Pub. Date: May 19, 2011

(54) SYSTEM AND METHOD FOR POLICY BASED AUTOMATED CONTROL OF BUILDING EQUIPMENT USING SYSTEMS MANAGEMENT

(75) Inventors: Kiran Prakash Diwakar, Maharashtra (IN); Jogarao Mallikarjuna Ryali, Fremont, CA (US)

(73) Assignee: Computer Associates Think, Inc., Islandia, NY (US)

(21) Appl. No.: 12/620,381

(22) Filed: Nov. 17, 2009

(51) Int. Cl. G05D 23/19

(52) U.S. Cl. 700/277; 700/276; 700/275; 700/90

(57) ABSTRACT

A system and method for automated control of building equipment. Systems management information including, for example, key stroke information, mouse movement information, host name information and/or IP address information may be utilized to determine a location of a managed resource in a building from which the systems management information is received. Based on, the systems management information, the determined location and/or one or more policies, one or more requests to control appropriate building equipment may be triggered.

### FIELD OF THE INVENTION

The invention relates to the field of building equipment control. More particularly, the invention relates to policy based automated control of building equipment.

### BACKGROUND OF THE INVENTION

A typical scenario for controlling building equipment requires multiple manual tasks to be performed. For example, a person experiencing a temperature change (e.g., cooler or warmer) may log into a Help Desk/Service Desk application and create a facilities ticket indicating a required temperature change. Helpdesk/facilities engineer(s) may manually find the exact location (e.g., floor, room, cubicle, etc.) for which the ticket was created. Once the location is found, the engineer may manually operate controls associated with building equipment (e.g., air conditioning/heating vents) to decrease or increase temperature based on the ticket. The engineer may then notify the person who created the ticket that a temperature adjustment has been made and may close the ticket.

As such, a typical help desk/service desk application may be used for accomplishing facilities related activities. This requires involvement of and manual effort by multiple people, which is time consuming. Moreover, in some instances, the temperature adjustment may be made after such adjustment is no longer required/desired (e.g., the person requesting the temperature change has left the building).

Typical building management systems may include in-built automation that may control temperature based on responses from sensors (for example, human motion sensors). These building management systems may interpret responses from the sensors as presence of a human being and may control the temperature accordingly. However, malfunctioning or non-functioning sensors may pose a problem because they may provide incorrect or no response to the building management systems. In some cases, false or pseudo motions may be detected by the sensors which may lead to improper control of building equipment. As such, the use of human motion sensors to control building management systems is error prone in addition to being relatively expensive. Also, it is important to ensure that the energy cost/utilizations are optimal in a given enterprise from cost as well as environment perspective.

These and other drawbacks exist.

### SUMMARY

In some implementations, the invention addressing these and other drawbacks of existing systems relates to a system and method for automated control of building equipment. The system may comprise, among other things, at least one server that is configured to receive systems management information associated with one or more managed resources and utilize the systems management information to determine building equipment elements to be controlled.

A mapping module utilizes the received systems management information to determine a location of a managed resource. In other words, the mapping module maps the system information to a specific location (e.g., zone, floor, room, cubicle, and/or other location) where the managed resource is located in the building. The received systems management information may include one or more of key stroke information, mouse movement information, host name information, IP address information, and/or other system information. Based on, for example, the systems management information, a determined location of the managed resource, and/or other criteria, the mapping module may determine one or more building equipment elements to be controlled. In some implementations, the mapping module may comprise one or more sub-modules which may include, but not be limited to, a human activity tracker module, a port-to-location mapping module, a location-to-equipment mapping module, and/or other sub-modules.

The human activity tracker module may track the received systems management information. Based on the received systems management information, human activity tracker module may determine that there is human presence around a managed resource from which the system information is received. Human activity tracker module may send the received systems management information to the port-to-location mapping module.

The port-to-location mapping module utilizes, for example, one or more of a host name and IP address information associated with a managed resource (i.e., from the received systems management information) to determine the physical location of the managed resource in the building. In some implementations, the port-to-location mapping module may receive IP address to physical port mapping information associated with the managed resource from, for example, an asset management tool. The port-to-location mapping module may determine the location of the managed resource based on the received systems management information and the received IP address to physical port mapping information.

The location-to-equipment mapping module may receive information regarding the determined location of the managed resource from the port-to-location mapping module. The location-to-equipment mapping module may determine one or more building equipment elements to be controlled based on the determined location. In some implementations, the location-to-equipment mapping module may receive building equipment layout information from, for example, a building management system. The location-to-equipment mapping module may map the determined location to the received building equipment layout information to determine the one or more building equipment elements to be controlled. Thus, the usage of the determined building equipment element may be increased or decreased so as to enable efficient management of energy catering.

In some implementations, once a determination regarding the building equipment elements to be controlled is made, one or more requests may be sent to a building management system to control the determined one or more building equipment elements.

In some implementations, a policy engine may analyze one or more policies to determine whether at least one of the policies applies based on, for example, the determined location and/or other information associated with the managed resource. One or more of the policies may be configured for one or more locations of the building. Policy engine may determine the building equipment elements to be, controlled based on, for example, the system information, the determined location, a policy (if any applies), and/or other criteria. One or more requests may then be sent to the building management system to control the determined building equipment elements.

Various other objects, features, and advantages of the invention will be apparent through the detailed description and the drawings attached hereto. It is also to be understood that both the foregoing general description and the following detailed description are exemplary and not restrictive of the scope of the invention.

### BRIEF DESCRIPTION OF THE DRAWINGS

FIG. 1 is an illustration of an example system for automated control of building equipment, according to various aspects of the invention.

FIG. 2 is an illustration of example components of a mapping server, according to various aspects of the invention.

FIG. 3 is a flowchart depicting example operations performed by one or more components of the system, according to various aspects of the invention.

### DETAILED DESCRIPTION OF THE INVENTION

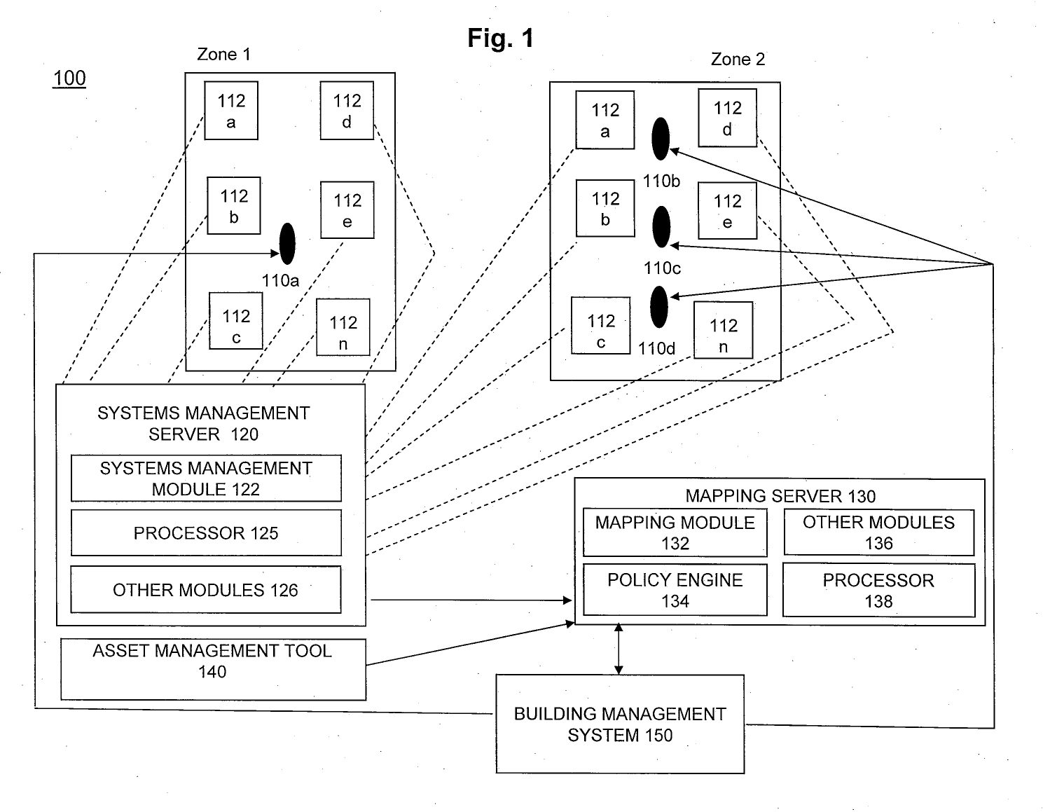

FIG. 1 is an exemplary illustration of a system 100 for automated control of building equipment, according to an aspect of the invention. System 100 may include, among other things, one or more servers that are configured to receive and process systems management information associated with one or more managed resources (not shown). System 100 may include a systems management server 120, a mapping server 130, an asset management tool 140, a building management system 150, and/or other components. Systems management server 120 may collect systems management information associated with the one or more managed resources. The one or more managed resources may include computers, desktops, workstations, servers, and/or other information technology hardware resources employed by one or more users in an enterprise. The one or more managed resources may be located at various locations (e.g., zones, floors, rooms, cubicles, and/or other locations) in a building. For example, as shown in FIG. 1, the managed resources may be located in one or more cubicles (112a, 112b, . . . , 112n) across different zones (for example, zone 1 and zone 2) in the building. While this disclosure describes various operations and functions being performed to control equipment associated with a single building, it will be understood that the disclosure is not limited to this description and may be appropriately applied to control equipment associated with multiple buildings, corporate or collegiate campus(es), home-based building(s), and/or other structures.

Systems management server 120 may include a processor 125, circuitry and/or other hardware operable to execute computer-readable instructions. According to one aspect of the invention, the system may include one or more tangible computer-readable storage media configured to store one or more software modules, wherein the software modules include computer-readable instructions that when executed by one or more processors may cause the processors to perform the functions described herein. According to one implementation, the systems management server 120 may comprise computer hardware programmed with a computer application having one or more software modules that enable the various features and functions described herein. Non-limiting examples of the software modules in the application may include one or more of a systems management module 122, and/or other modules 126, for performing the features and functions described herein.

Systems management module 122 may collect systems management information associated with the one or more managed resources. The systems management information may include information relating to managed resources such as, for example, key stroke information, mouse movement information, host name information, IP address information, and/or other systems management information. Systems management module 122 may subscribe to mouse, keyboard, and/or other system events to collect the systems management information. In some implementations, systems management module 122 may register with the native operating system associated with a managed resources to send signals regarding key strokes, mouse movement, and/or other systems management information. In some implementations, the managed resources may run one or more agents that may gather the systems management information associated with the managed resources. Systems management module 122 may collect the gathered systems management information from the agents running on the managed resources. In some implementations, the agents may be run on the systems management server 120, and in some cases be run in a distributed fashion on the managed resources and the systems management server 120.

Systems management module 122 may collate the collected systems management information and may send the system information to mapping server 130. Mapping server 130 may be configured to receive systems management information associated with the one or more managed resources from systems management server 120. The mapping server 130 may include a processor 138, circuitry and/or other hardware operable to execute computer-readable instructions. According to one aspect of the invention, the system may include one or more tangible computer-readable storage media configured to store one or more software modules, wherein the software modules include computer-readable instructions that when executed by one or more processors may cause the processors to perform the functions described herein. According to one implementation, the mapping server 130 may comprise computer hardware programmed with a computer application having one or more software modules that enable the various features and functions of the invention. Non-limiting examples of the software modules in the application may include one or more of a mapping module 132, a policy engine 134, and/or other modules 136, for performing the features and functions described herein. While the systems management server 120 and mapping server 130 are depicted and described as separate components, it will be understood that they may be combined into one server that may perform the various operations and functions described herein.

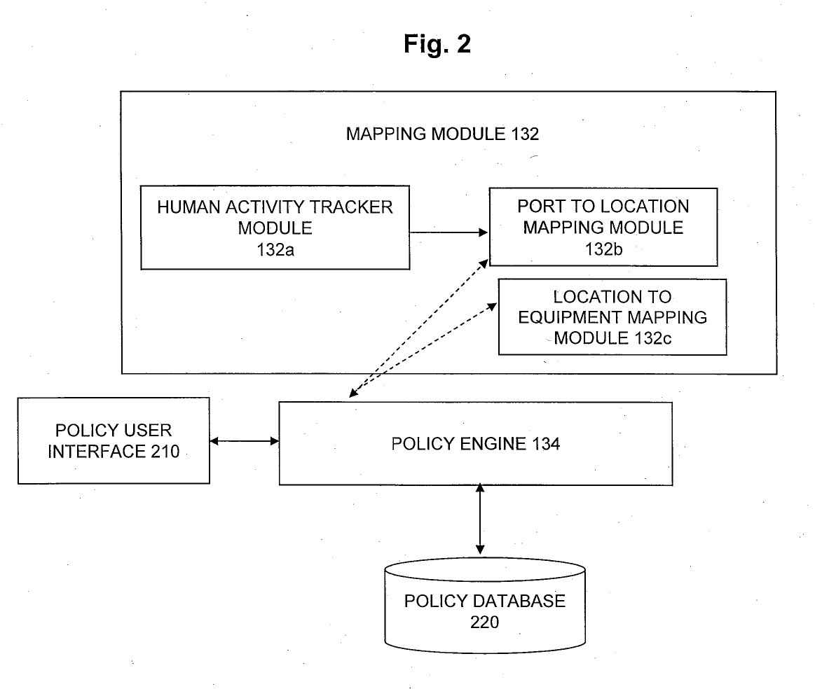

The mapping module 132 may, based on the received systems management information, determine that there is human presence around a managed resource from which the system information is received (or otherwise determine that control of certain building equipment is desirable). Mapping module 132 may utilize the received systems management information to determine a location of the managed resource. In other words, the mapping module 132 maps the systems management information to a specific location (e.g., zone, floor, room, cubicle, and/or other location) where the managed resource is located in the building. In some implementations, mapping module 132 may utilize information from an asset management tool 140 (or some other tool) to determine the physical location of the managed resource in the building. Based on, for example, the systems management information, the determined location of the managed resource, and/or other criteria, mapping module 132 may determine one or more building equipment elements to be controlled. The one or more building equipment elements may include any energy consuming building equipment such as, for example, air conditioning (AC) vents, condensers, fans/blowers, and/or other AC-related equipment; lights; curtains or blinds; heating vents, heating elements, fans/blowers, and/or other heating-related equipment; and/or other building equipment elements that directly or indirectly contribute wo electricity/energy consumption. In an example implementation, FIG. 1 illustrates AC vents 110a, 110b, 110c, 110d distributed in zones 1 and 2. The layout of AC vents within a particular zone in a building may be per group of cubicles (allowing coarse control) as in zone 1, or per-cubicle (allowing more granular control) as in zone 2. It should be understood that the layout of vents depicted in FIG. 2 is exemplary and other layouts may be utilized without departing from the scope of the disclosure. Also, while this disclosure describes various operations and functions being performed with respect to AC vents, it will be understood that the disclosure is not limited to only AC vents and may be appropriately applied to control other types of building equipment elements without departing from the scope of the disclosure.

In some implementations, once a determination regarding the building equipment elements to be controlled is made, one or more requests may be sent to a building management system 150 to control the determined one or more building equipment elements. For example, based on the received systems management information associated with a managed resource located in, for example cubicle 112e in zone 2, it may be determined that AC vent 110c needs to be controlled. Accordingly, mapping module 132 may send a request to building management system 150 to control the AC vent 110c in zone 2.

In some implementations, a policy engine 134 may analyze one or more policies to determine whether at least one of the policies applies based on, for example, the determined location and/or other information associated with the managed resource. The one or more policies may be configured for one or more locations of the building. Policy engine 134 may determine the building equipment elements to be controlled based on, for example, the systems management information, the determined location, the at least one policy, and/or other criteria. One or more requests may then be sent by mapping module 132 and/or policy engine 134 to the building management system 150 to control the determined building equipment elements.

FIG. 2 is an illustration of example components of mapping server 130, according to various aspects of the invention. In some implementations, mapping module 132 may comprise one or more sub-modules which may include, but not be limited to, a human activity tracker module 132a, a port-to-location mapping module 132b, a location-to-equipment mapping module 132c, and/or other sub-modules.

The human activity tracker module 132a may track the received systems management information. Based on the received systems management information, human activity tracker module 132a may determine that there is human presence around the managed resource from which the systems management information is received. Human activity tracker module 132a may send the received systems management information to the port-to-location mapping module 132b. In some implementations, human activity tracker module 132a may send the systems management information in response to a determination of human presence.

In one example, port-to-location mapping module 132b utilizes, for example, one or more of the host name and IP address information associated with a managed resource (i.e., from the received systems management information) to determine the physical location of the managed resource in the building. In some implementations, port-to-location mapping module 132b may receive IP address to physical port mapping information associated with the managed resource from, for example, an asset management tool 140 or some other tool. The IP address to physical port mapping information may include information that maps IP addresses of managed resources to network/physical ports to which they are connected. Port-to-location mapping module 132b may determine the location of the managed resource based on the received systems management information and the received IP address to physical port mapping information. In some implementations, once the network/physical port to which a particular managed resource is connected to is determined, port-to-location mapping module 132b may determine the location, for example, a cubicle where the network/physical port is located and hence the location of the managed resource (i.e., the cubicle). In some implementations, port-to-location mapping module 132b may receive building port layout information from, for example, building management system 150 to determine which location in the building maps to the determined network/physical port. In some implementations, the asset management tool, in addition to the IP address to physical port mapping information, may also provide physical port-to-location mapping information that may include information regarding where the various physical/network ports are located in the building.

Location-to-equipment mapping module 132c may receive information regarding the determined location of the managed resource from port-to-location mapping module 132b. Location-to-equipment mapping module 132c may determine one or more building equipment elements, for example, AC vents 110a, 110b, 110c, 110d, to be controlled based on the determined location. In some implementations, location-to-equipment mapping module 132c may receive building equipment layout information from, for example, building management system 150. Location-to-equipment mapping module 132c may map the determined location to the received building equipment layout information to determine the one or more building equipment elements to be controlled. The building equipment layout information may include information that maps various locations in the building to one or more building equipment elements, for example, AC vents 110a, 110b, 110c, 110d. For example, building equipment layout information may map cubicles 112a, 112b, . . . , 112n in zone 1 to AC vent 110a.

In some implementations, once a determination regarding the building equipment elements to be controlled is made, for example AC vent 110a indicated above, mapping module 132 may send one or more requests to building management system 150 to control the determined building equipment elements. The one or more requests may include event information to trigger actuation or de-actuation of the building equipment elements. For example, a request may be sent to control AC vent 110a to increase or decrease temperature, turn on or off the vent, and/or perform other controls.

In some implementations, prior to sending the requests to the building management system, policy engine 134 may analyze one or more policies to determine whether at least one of the policies applies based on the determined location and/or other information associated with the managed resource, for example. The one or more policies may be created and/or updated by one or more users via a policy user interface 210. The policy user interface 210 may be associated with a client device (not shown) utilized by a user to interact with mapping server 130. The policies may be configured for one or more criteria, for example, one or more locations in the building, one or more network ports in the building, one or more building equipment elements, and/or other criteria. Policy engine 134 may store the policies in a policy database 220. Policy engine 134 may apply appropriate policies and make intelligent decisions regarding which policies to apply. In some implementations, policy engine 134 may filter the requests to the building management system 150 generated by mapping module 132 based on the policies. For example, a policy for zone 1 may be created which indicates that AC vents need not be controlled, which could be due to malfunctioning AC vents or some other reason. As such, in this case, even if mapping module 132 determines AC vent 110a is to be controlled, due to the policy set in the policy engine 134, no requests may be sent to the building management system 150 to control AC vent 110a. Another example policy may be created for zone 1 and/or zone 2 which indicates that if no key stroke or mouse movement information is received from the systems management module 122 (indicating no human presence) for a pre-defined period of time, then AC vents should be turned off for zone 1 and/or zone 2.

In some implementations, mapping module 132 and/or policy engine 134 may determine which building equipment elements are to be controlled based on, the systems management information, the determined location and/or at least one policy determined to be applicable by policy engine 134 based on the determined location and/or other information associated with the managed resource. For example, in some cases, network port information, building equipment information, and/or other information from mapping module 132 may also be used to determine an applicable policy. One or more requests may then be sent to the building management system to control the determined building equipment elements. The one or more requests may include event information to trigger actuation or de-actuation of the building equipment elements.

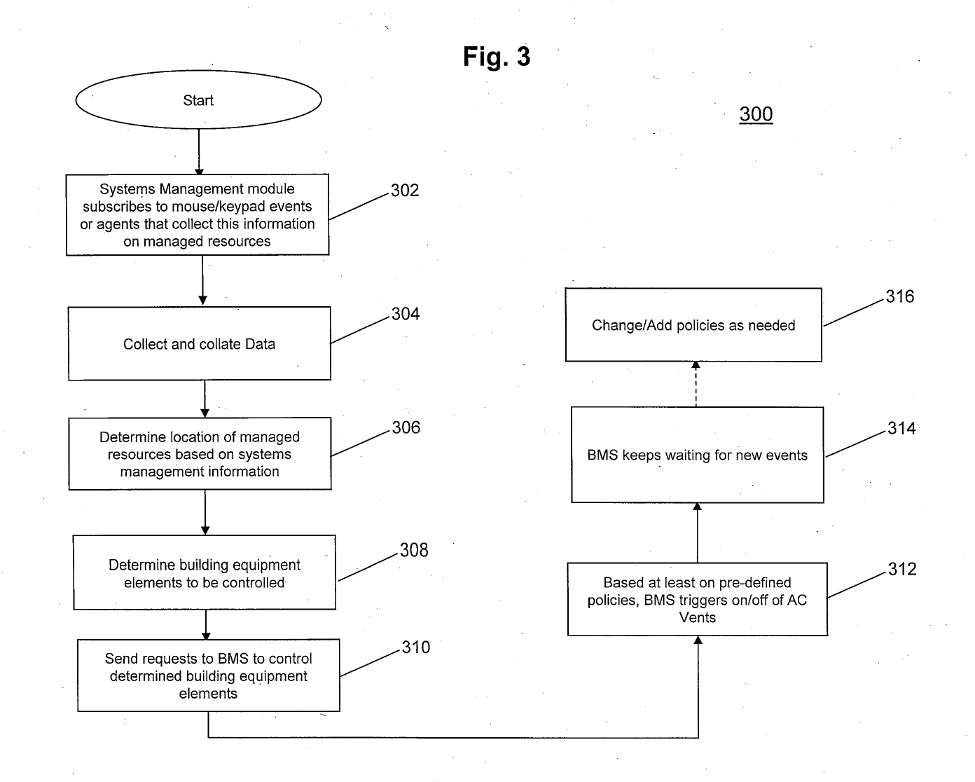

FIG. 3 is a flowchart 300 depicting operations performed by one or more components of system 100, according to various aspects of the invention. The described operations may be accomplished using one or more of modules/sub-modules described herein and in some implementations, various operations may be performed in different sequences. In other implementations, additional operations may be performed along with some or all of the operations shown in FIG. 3. In yet other implementations, one or more operations may be performed simultaneously. In yet other implementations, one or more of operations may not be performed. Accordingly, the operations described are exemplary in nature and, as such, should not be viewed as limiting.

In an operation 302, a subscription may be made to mouse, keyboard, and/or other system events associated with one or more managed resources or one or more agents running on the managed resources to collect systems management information associated with the managed resources. In an operation systems management information may be collected from the managed resources based on the mouse/keyboard events and/or agents and the collected information may be collated. In an operation 306, location of the managed resources may be determined based on the received systems management information. In an operation 308, building equipment elements to be controlled may be determined based on the systems management information, determined location and/or one or more pre-defined policies. In an operation 310, one or more requests to control the building equipment elements may be sent to a building management system. In an operation 312, the building management system may accordingly control the building equipment elements, for example, turn on/off AC vents etc. The building management system may keep waiting for further requests to control building equipment in an operation 314. An operation 316 illustrates that policies may be changed, added, and/or deleted as and when needed to ensure that appropriate policies are utilized to make determinations regarding which building equipment elements need to be controlled.

In some implementations, in cases where systems management module 122 is not configured to directly collect the key stroke, mouse movement or other systems management information, new data types may be created, appropriate mechanisms such as new object identifiers (OIDs) in case of SNMP based data collection may be added, and/or appropriate logic to collect the new type of systems management information and/or temperature information may be added such that appropriate building equipment control using policies as described herein may be achieved without departing from the scope of the disclosure.

Implementations of the invention may be made in hardware, firmware, software, or various combinations thereof. The invention may also be implemented as computer-readable instructions stored on a tangible computer-readable storage medium which may be read and executed by one or more processors. A computer-readable storage medium may include various mechanisms for storing information in a form readable by a computing device. For example, a tangible computer-readable storage medium may include optical storage media, flash memory devices, and/or other storage mediums. Further, firmware, software, routines, or instructions may be described in the above disclosure in terms of specific exemplary aspects and implementations of the invention, and performing certain actions. However, it will be apparent that such descriptions are merely for convenience, and that such actions may in fact result from computing devices, processors, controllers, or other devices executing firmware, software, routines or instructions.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for automated control of building equipment, the method comprising:
receiving systems management information associated with one or more managed resources;
determining a location of the one or more managed resources in a building based on the received systems management information;
determining one or more building equipment elements to be controlled based on the determined location and one or more policies;
transmitting one or more requests to a building management system to control the determined one or more building equipment elements.

2. The method of claim 1, wherein the systems management information comprises key stroke information, mouse movement information, host name information and IP address information.

3. The method of claim 2, further comprising:
receiving IP address to physical port mapping information that maps an IP address of the one or more managed resources with a physical port that the one or more managed resources are connected to.

4. The method of claim 3, wherein said determining a location further comprises determining the location of the one or more managed resources based on the received system information and the received IP address to physical port mapping information.

5. The method of claim 1, wherein the one or more building equipment elements comprise one or more of air conditioning vents, lights, curtains or blinds, and heating vents.

6. The method of claim 1, further comprising:
receiving building equipment layout information from the building management system; and
mapping the determined location to the received building equipment layout information to determine the one or more building equipment elements to be controlled.

7. The method of claim 6, further comprising:
configuring the one or more policies for one or more locations of the building;
analyzing the one or more policies to determine whether at least one of the policies applies based on the determined location; and
determining the one or more building equipment elements to be controlled based on the determined location and the at least one policy.

8. The method of claim 1, wherein the one or more requests comprise event information to trigger actuation or de-actuation of the one or more building equipment elements.

9. A tangible computer-readable storage medium having one or more computer-readable instructions thereon which when executed by one or more processors cause the one or more processors to:
receive systems management information associated with one or more managed resources;
determine a location of the one or more managed resources in a building based on the received systems management information;
determine one or more building equipment elements to be controlled based on the determined location and one or more policies;
transmit one or more requests to a building management system to control the determined one or more building equipment elements.

10. The tangible computer-readable storage medium of claim 9, wherein the one or more instructions further cause the one or more processers to:
receive IP address to physical port mapping information that maps an IP address of the one or more managed resources with a physical port that the one or more managed resources are connected to.

11. The tangible computer-readable storage medium of claim 10, wherein the one or more instructions further cause the one or more processers to:
determine the location of the one or more managed resources based on the received systems management information and the received IP address to physical port mapping information.

12. The tangible computer-readable storage medium of claim 9, wherein the one or more instructions further cause the one or more processers to:
receive building equipment layout information from the building management system; and
map the determined location to the received building equipment layout information to determine the one or more building equipment elements to be controlled.

13. The tangible computer-readable storage medium of claim 9, wherein the one or more instructions further cause the one or more processers to:
configure the one or more policies for one or more locations of the building;
analyze the one or more policies to determine whether at least one of the policies applies based on the determined location; and
determine the one or more building equipment elements to be controlled based on the determined location and the at least one policy.

14. The tangible computer-readable storage medium of claim 9, wherein the one or more requests comprise event information to trigger actuation or de-actuation of the one or more building equipment elements.

15. A system for automated control of building equipment, the system comprising:
one or more processors configured to:
receive systems management information associated with one or more managed resources;
determine a location of the one or more managed resources in a building based on the received systems management information;
determine one or more building equipment elements to be controlled based on the determined location and one or more policies;
transmit one or more requests to a building management system to control the determined one or more building equipment elements.

16. The system of claim 15, wherein the one or more processors are further configured to:
receive IP address to physical port mapping information that maps an IP address of the one or more managed resources with a physical port that the one or more managed resources are connected to.

17. The system of claim 16, wherein the one or more processors are further configured to:
determine the location of the one or more managed resources based on the received systems management information and the received IP address to physical port mapping information.

18. The system of claim 15, wherein the one or more processers are further configured to:
receive building equipment layout information from the building management system; and
map the determined location to the received building equipment layout information to determine the one or more building equipment elements to be controlled.

19. The system of claim 15, wherein the one or more processers are further configured to:
configure the one or more policies for one or more locations of the building;
analyze the one or more policies to determine whether at least one of the policies applies based on the determined location; and
determine the one or more building equipment elements to be controlled based on the determined location and the at least one policy.

20. The system of claim 15, wherein the one or more requests comprise event information to trigger actuation or de-actuation of the one or more building equipment elements.
